(19) United States
(12) Patent Application Publication
(10) Pub. No.: US 2026/0133593 A1
(43) Pub. Date: May 14, 2026

(54) TARGET TRUCK IDENTIFICATION AND SELECTION SYSTEM FOR A MATERIAL TRANSFER VEHICLE

(71) Applicant: Deere & Company, Moline, IL (US)

(72) Inventors: Stephen R. CORBAN, Geneseo, IL (US); Grant J. WONDERLICH, Milan, IL (US); Ryan C. RUSSELL, Orion, IL (US)

(21) Appl. No.: 18/946,495

(22) Filed: Nov. 13, 2024

(51) Int. Cl. G05D 1/698; A01D 90/16; G05D 107/20

(52) U.S. Cl. CPC G05D 1/6987; A01D 90/16; G05D 2107/21

(57) ABSTRACT

A target identification system identifies a plurality of possible target trucks for receiving material from a material transfer vehicle. The target identification system generates an output indicative of the possible target trucks to a selection system. The selection system processes one or more selection criteria and selects a target truck based on the selection criteria. A control signal is generated to control the material transfer vehicle based upon the selected target truck.

### FIELD OF THE DESCRIPTION

The present descriptions relate to mobile agricultural machines. More specifically, the present description relates to identifying a target truck to receive material unloaded from an agricultural material transfer vehicle.

### BACKGROUND

There is a wide variety of different types of agricultural equipment. Some such agricultural equipment includes agricultural harvesters and material transfer vehicles. Agricultural harvesters often engage crop, process that crop, and unload that crop into a material transfer vehicle, such as a tractor-pulled grain cart (for example).

The discussion above is merely provided for general background information and is not intended to be used as an aid in determining the scope of the claimed subject matter.

### SUMMARY

A target identification system identifies a plurality of possible target trucks for receiving material from a material transfer vehicle. The target identification system generates an output indicative of the possible target trucks to a selection system. The selection system processes one or more selection criteria and selects a target truck based on the selection criteria. A control signal is generated to control the material transfer vehicle based upon the selected target truck.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIGS. 1, 2, 3, and 4 are partial pictorial, partial block diagrams of examples of an agricultural system.

FIG. 5 is a block diagram showing one example of an unloading target identification and selection system.

FIG. 6 is a flow diagram illustrating one example of the operation of an unloading target identification and selection system.

FIG. 7 is a block diagram showing one example of a truck identification system.

FIG. 8 is a flow diagram illustrating one example of the operation of a truck identification system.

FIG. 9 is a block diagram showing one example of a target truck selection system.

FIG. 10 is a flow diagram illustrating one example of the operation of a target truck selection system.

FIG. 11 is a block diagram showing one example of the agricultural system shown in other figures, deployed in a remote server environment.

FIGS. 12, 13, and 14 show examples of mobile devices that can be used in the architectures and systems shown in other figures.

FIG. 15 is a block diagram showing one example of a computing environment that can be used in the systems and architectures shown in other figures.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

Once a grain cart is filled to a desired fill level, a propulsion vehicle (such as a tractor or other vehicle) that pulls the grain cart navigates toward a haulage vehicle, such as a semi-trailer, pulls alongside the haulage vehicle, and transfers harvested material to the haulage vehicle. As the propulsion vehicle approaches the haulage vehicle, a control system or operator positions an unloading spout or auger, and then, once alongside the haulage vehicle, engages the unloading auger on the grain cart to unload the harvested material from the grain cart into the haulage vehicle.

As discussed above, agricultural harvesters often unload harvested material into a material transfer vehicle. The material transfer vehicle then transfers the material to the location of a haulage vehicle where the material transfer vehicle unloads the material into the haulage vehicle. The haulage vehicle may be a semi-trailer or a grain truck or another type of haulage vehicle. It can happen that there are multiple haulage vehicles waiting to be loaded. Therefore, it can be difficult for an operator of a material transfer vehicle to identify which of the haulage vehicles is the best target for unloading. Further, as automation of the material transfer vehicle increases, the problem may be exacerbated in that an automated control system may find it difficult to determine which haulage vehicle should be loaded first.

The present description thus proceeds with respect to a system that automatically determines when a plurality of different haulage vehicles are present. The system then identifies which of those plurality of haulage vehicles are potential unloading targets for the material transfer vehicle. Then, using selection criteria, the system selects one of the haulage vehicles as the target for unloading. A control signal can be generated based upon the selected target. For instance, the material transfer vehicle can be automatically controlled to approach the target haulage vehicle and perform an unloading operation. In addition, a communication system can be controlled to communicate with an operator of the target haulage vehicle to move the target haulage vehicle to a desired loading zone. Other control signals can be generated as well. As used herein, automatically means, in one example, that the step, process, function, or method is performed without further human involvement except, perhaps, to initiate or authorize the step, process, function, or method.

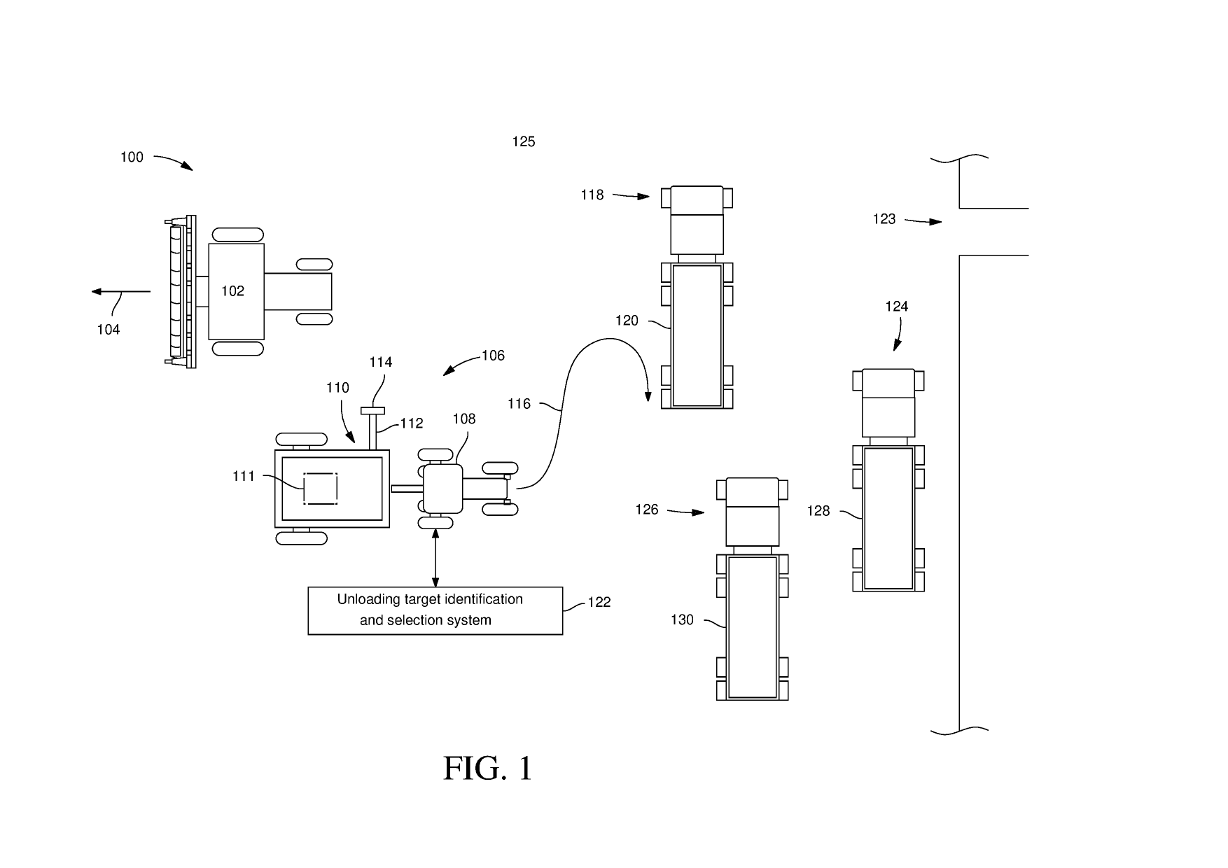

FIG. 1 is a pictorial illustration of one example of an agricultural system 100 in which a harvester 102 is moving through field in a direction indicated by arrow 104. A material transfer vehicle 106 includes a propulsion vehicle (e.g., a tractor) 108 and a grain cart 110. Grain cart 110 is shown having a conveyor 112 and a spout 114 that are used to unload harvested material from grain cart 110. Conveyor 112 may be a conveyor (such as an auger) that conveys material from grain cart 110 through a housing and out an exit end of conveyor 112. Spout 114 may be disposed on an exit end to direct material as the material exits through the exit end of conveyor 112. FIG. 1 also shows that grain cart 110 has a gate 111 disposed at the bottom of grain cart 110. To facilitate the transfer of material out of grain cart 110, the gate 111 is opened to a desired position which allows the grain to fall into a hopper or into another collection basin where the grain can be transferred by conveyor 112.

In the example shown in FIG. 1, grain cart 110 has been filled with harvested material from harvester 102 and is traveling along a travel path back toward a plurality of haulage vehicles 118, 124, and 126. The haulage vehicles are parked proximate an entry/exit point 123 in a field 125. Haulage vehicle 118 is a semi-truck that includes a semi-trailer 120. Haulage vehicle 124 is also a semi-truck that includes a semi-trailer 128, and haulage vehicle 126 is a semi-truck that includes a semi-trailer 130.

As material transfer vehicle 106 approaches the haulage vehicles 118, 124, and 126, it can be difficult for an operator (a human operator, an automated operator, or a semi-automated operator) to identify which of the haulage vehicles 118, 124, and 126 should be considered the target vehicle for unloading. Therefore, in accordance with one example, unloading target identification and selection system 122 identifies that there are a plurality of haulage vehicles 118, 124, and 126 present and that, of those vehicles, there are a plurality of possible target haulage vehicles that could receive material from material transfer vehicle 106. Then, based upon selection criteria, unloading target identification and selection system 122 selects one of the haulage vehicles 118, 124, and 126 as the target haulage vehicle (the haulage vehicle that is to receive material from material transfer vehicle 106). In the example shown in FIG. 1, unloading target identification and selection system 122 has identified haulage vehicle 118 as the target haulage vehicle. Therefore, material transfer vehicle 106 is controlled to follow the travel path 116 to move adjacent semi-trailer 120 so that material can be unloaded from grain cart 110 into semi-trailer 120.

To unload material from grain cart 110, an operator actuates an actuator to position conveyor 112 to a deployed position. Tractor 108 pulls the grain cart 110 alongside of semi-trailer 120 so that the conveyor 112 can be engaged to transfer material from grain cart 110 into semi-trailer 120. In one example, the spout 114 is movable to change the direction of material exiting conveyor 112 and to thus change the landing point of material inside semi-trailer 120. Also, in one example, conveyor 112 is driven by a power take off on tractor 108, although it may be driven by other actuators as well. The speed of the power takeoff or other actuator can be controlled to change the landing point as well.

In one example, it will be assumed that unloading target identification and selection system 122 may be located on material transfer vehicle 106. In another example, system 122 may be located in a remote server environment or dispersed among different locations. For instance, some portions of unloading target identification and selection system 122 may be located on material transfer vehicle 106 while other portions are located on haulage vehicles 118, 124, and 126 and still other portions may be located in a remote server environment or on other machines or elsewhere.

Similarly, it is assumed that unloading target identification selection system 122 can include sensors that allow system 122 to sense values which may be indicative of truck identification criteria and truck selection criteria. For instance, unloading target identification and selection system 122 may have a location sensor that senses the location of material transfer vehicle 106 in a local or global coordinate system. System 122 may also have sensors that sense the location of the haulage vehicles 118, 124, and 126 either relative to material transfer vehicle 106 or as coordinates within a local or global coordinate system. For instance, unloading target identification and selection system 122 may have a global navigation satellite system (GNSS) receiver that senses the location of material transfer vehicle 106 and radar, lidar, ultrasound, or other sensors that sense the location of the haulage vehicles relative to material transfer vehicle 106. Unloading target identification and selection system 122 may also have a communication system that allows the haulage vehicles 118, 124, and 126 to communicate their location to unloading target identification and selection system 122. Further, system 122 may have access to maps or other information that identify the location of the entry/exit point 123, or other features of field 125 that may be used in identifying and selecting a target haulage vehicle. These and other items of functionality will be described in greater detail below with respect to other FIGs.

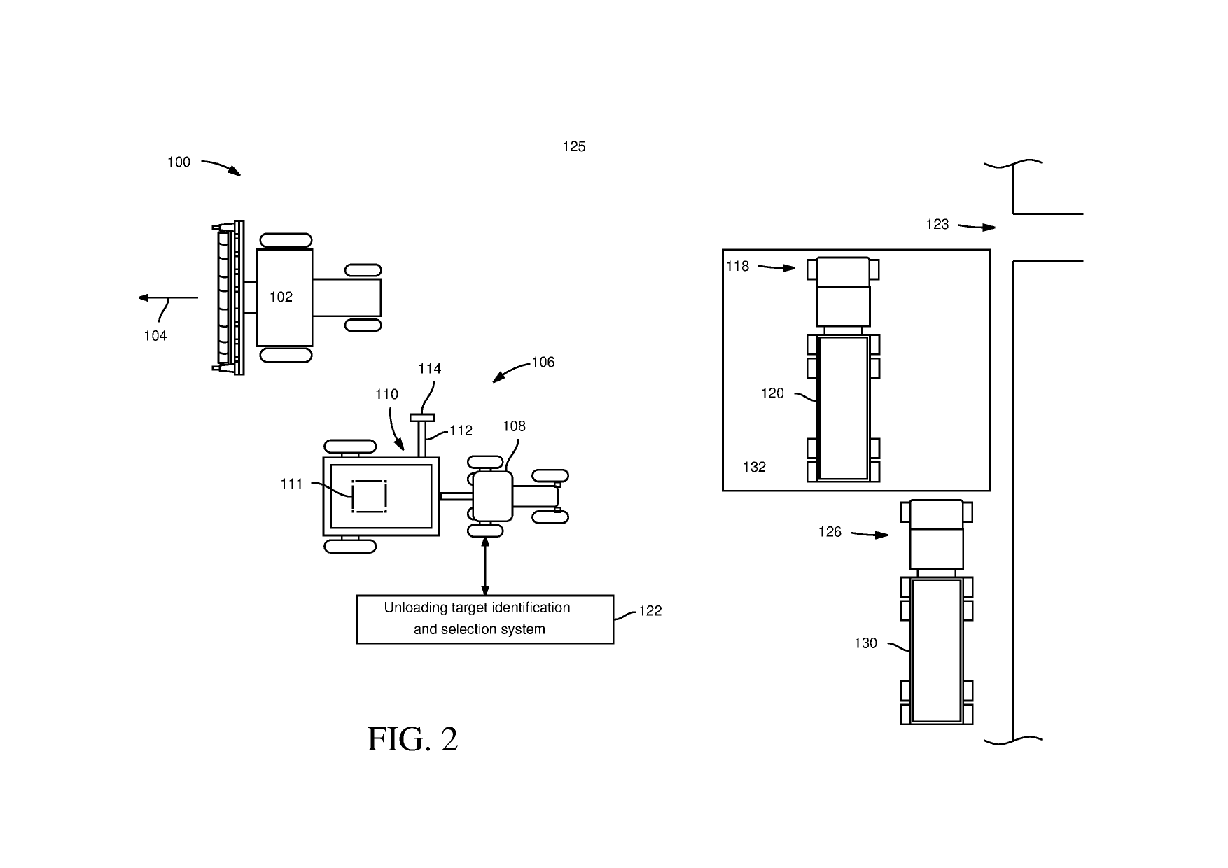

It will be noted that there may be a variety of different selection criteria that can be used to select the target haulage vehicle. FIGS. 2-4 illustrate different scenarios in which different examples of selection criteria may be used

FIG. 2 is similar to FIG. 1, and similar items are similarly numbered. However, FIG. 2 shows that haulage vehicle 118 is parked in a pre-defined unloading zone 132 while haulage vehicle 126 is parked outside of the loading zone 132 and behind haulage vehicle 118 relative to the field entry/exit point 123. Assume for the sake of discussing FIG. 2 that both haulage vehicles 118 and 126 are evaluated against a set of selection criteria to have the same priority. However, assume further that haulage vehicle 118 arrived in the field before haulage vehicle 126. Then, depending upon the selection criteria, one of the haulage vehicles 118 and 126 will be selected for receiving material from material transfer vehicle 106. For example, if the selection criteria are first – in – first – out (FIFO) criteria, then haulage vehicle 118 will be selected as the target haulage vehicle because it arrived prior to haulage vehicle 126. If the selection criteria comprise which haulage vehicle is closest to the field entry/exit point 123, then, again, haulage vehicle 118 will be selected as the target haulage vehicle because it is located closer to the field entry/exit point 123 than haulage vehicle 126. However, if the selection criteria comprise which vehicle is closer to grain cart 110, then the distance between haulage vehicle 118 and grain cart 110, is compared against the distance between haulage vehicle 126 and grain cart 110. The closest of the two haulage vehicles will then be selected as the target haulage vehicle. If the selection criteria comprise which vehicle is located in, or closest to, the unloading zone 132, then haulage vehicle 118 will be selected as the target haulage vehicle because it is parked within unloading zone 132, while haulage vehicle 126 is outside of unloading zone 132. Other selection criteria may be considered by unloading target identification and selection system 122 as well. For instance, it may be that the selection criteria comprise the time or distance that a haulage vehicle has to travel once it is loaded (e.g., the distance or time for haulage vehicle to travel to an elevator or other storage facility).

In another example, assume that, with respect to FIG. 2, haulage vehicle 126 is assigned a higher priority than haulage vehicle 118. The priority may be assigned for a variety of different reasons. For instance, if haulage vehicle 118 is owned by a contract organization that charges a lower rate than the organization that owns haulage vehicle 126, then the priority of the two haulage vehicles 118 and 126 may be assigned based upon the cost associated with using each of the haulage vehicles. In that case, even though haulage vehicle 118 is parked in the unloading zone 132, arrived before haulage vehicle 126, and is closer to the entry/exit point 123, the priority assigned to haulage vehicle 126 may be higher than the priority assigned to haulage vehicle 118. In that case, unloading target identification and selection system 122 may select haulage vehicle 126 as the target haulage vehicle instead of haulage vehicle 118. Thus, material transfer vehicle 106 will move to haulage vehicle 126 and unload material into semi-trailer 130.

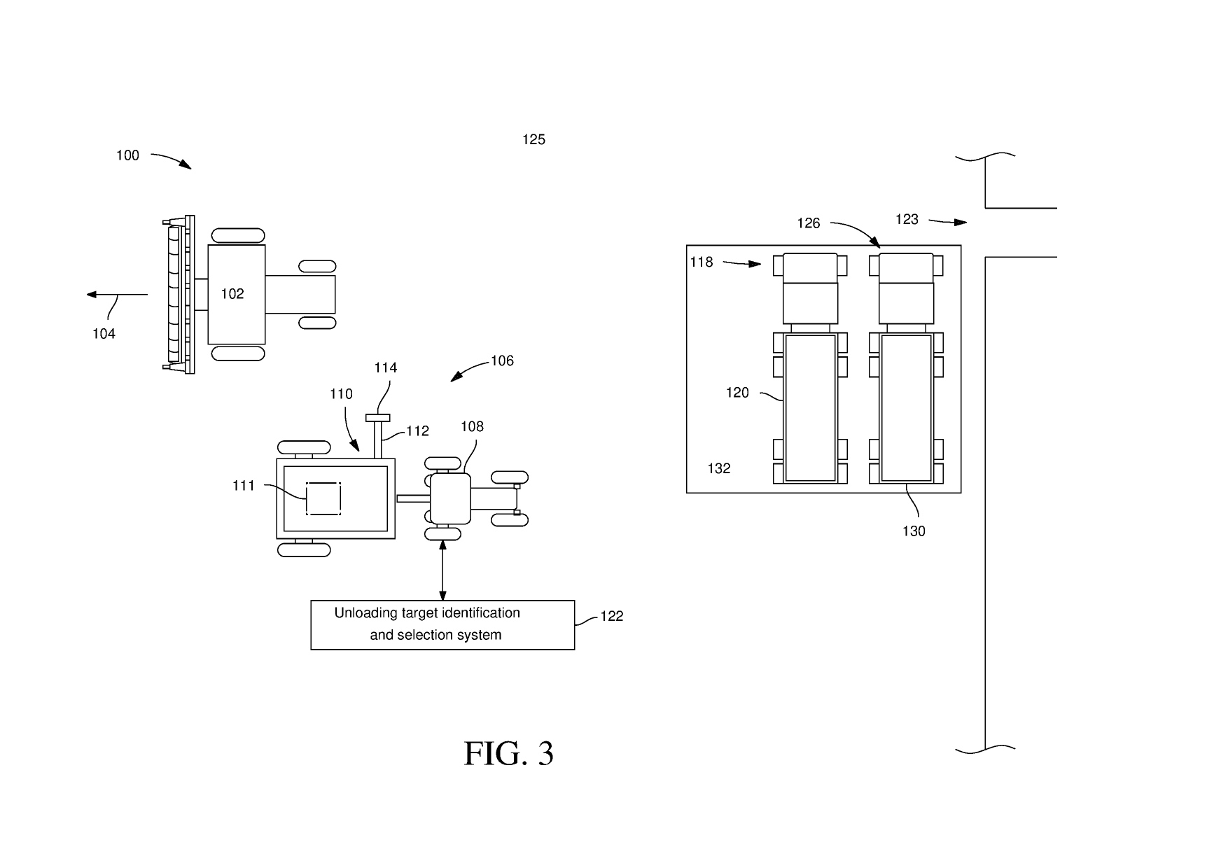

FIG. 3 shows another example in which various selection criteria can be used by unloading target identification and selection system 122 in order to select a target haulage vehicle. Some items in FIG. 3 are similar to those shown in FIGS. 1 and 2, and those items are similarly numbered. In FIG. 3, it can be seen that both haulage vehicles 118 and 126 are parked in unloading zone one 132. However, because haulage vehicles 118 and 126 are parked closely adjacent one another, the only haulage vehicle that is available to be loaded by material transfer vehicle 106 is haulage vehicle 118. That is because there is no room on either side of haulage vehicle 126 for material transfer vehicle 106 to position itself in order to unload material into semi-trailer 130. Therefore, even if haulage vehicle 126 arrived before haulage vehicle 118, and even if haulage vehicle 126 is closer to the entry/exit point 123 of field 125, unloading target identification and selection system 122 will select haulage vehicle 118 as the target haulage vehicle, because it is the only haulage vehicle accessible to material transfer vehicle 106. Thus, once haulage vehicle 118 is selected as the target haulage vehicle, control signals can be generated to move material transfer vehicle 106 along semi-trailer 120 to unload material from grain cart 110 into semi-trailer 120.

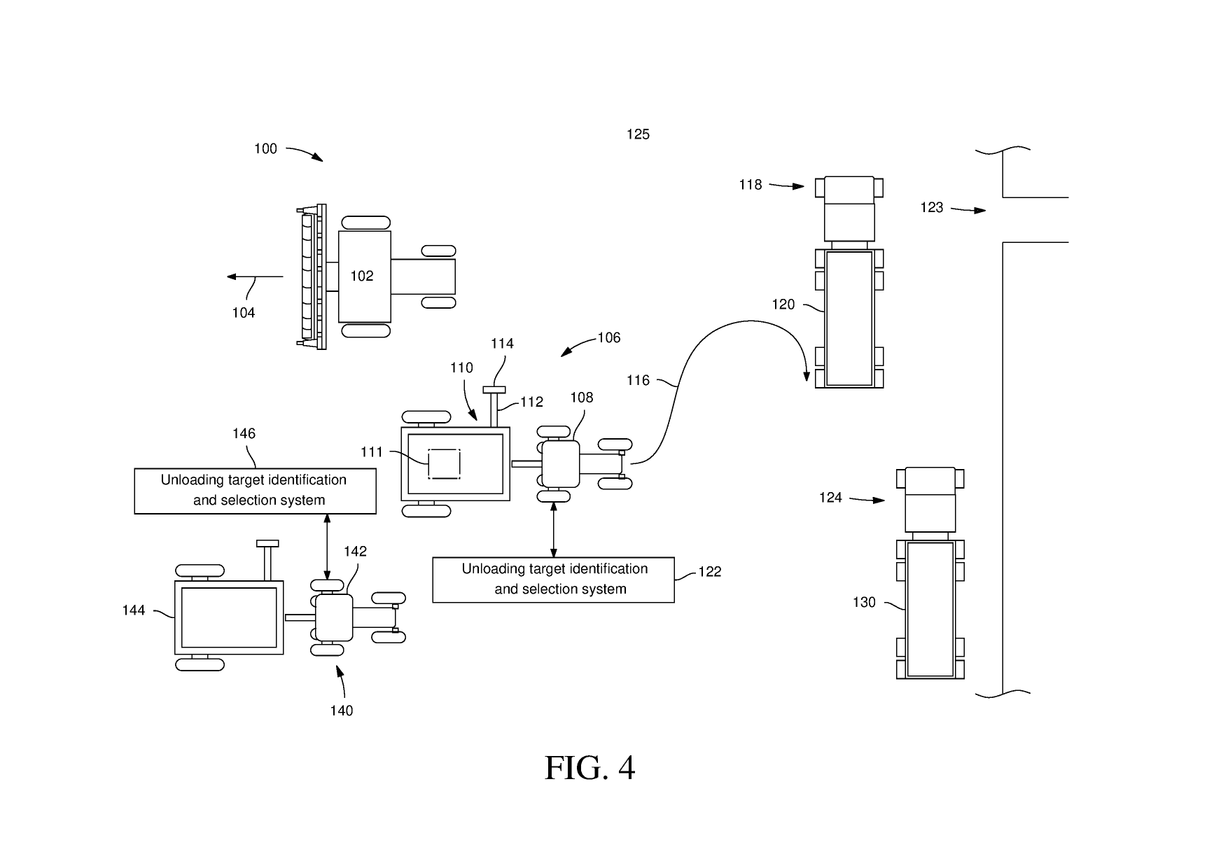

FIG. 4 shows yet another example of how different selection criteria can be used. Some items in FIG. 4 are similar to those shown in FIGS. 1-3 and those items are similarly numbered. However, FIG. 4 shows that agricultural system 100 includes a second material transfer vehicle 140 that has a propulsion vehicle (e.g., a tractor) 142 pulling a grain cart 144. Material transfer vehicle 140 also has an unloading target identification and selection system 146. It will be appreciated that systems 122 and 146 can be combined into a single system or they can be two systems that share functionality, or two separate systems. These and other examples are contemplated herein.

In the example shown in FIG. 4, it is assumed that material transfer vehicles 118 and 124 are identified as being possible target haulage vehicles. It is also assumed for the sake of the description of FIG. 4 that material transfer vehicle 106 has already been assigned to haulage vehicle 118. That is, it is assumed that unloading target identification and selection system 122 has selected haulage vehicle 118 as the target haulage vehicle for material transfer vehicle 106. Therefore, unloading target identification and selection system 146 will analyze the truck assignment data and determine that haulage vehicle 118 has already been assigned to material transfer vehicle 106. In that case, regardless of other priorities, unloading target identification and selection system 146 will determine that haulage vehicle 124 is the only unassigned haulage vehicle that is a possible target haulage vehicle. Unloading target identification and selection system 146 will thus select haulage vehicle 124 as the target haulage vehicle for material transfer vehicle 140. Control signals will then be generated to control material transfer vehicle 140 to approach haulage vehicle 124 and unload material from cart grain cart 144 into semi-trailer 130.

In yet another example, unloading target identification selection system 146 may receive data indicative of the remaining capacity in semi-trailer 120 and indicative of the amount of harvested material carried by grain cart 110. Thus, system 146 can determine whether the contents of grain cart 110 will fill the remaining capacity of semi-trailer 120. If not, then system 146 may select haulage vehicle 118 as the target haulage vehicle for material transfer vehicle 140 even though it is already assigned as the target haulage vehicle for material transfer vehicle 106. These and other criteria can be used to select a target truck as well.

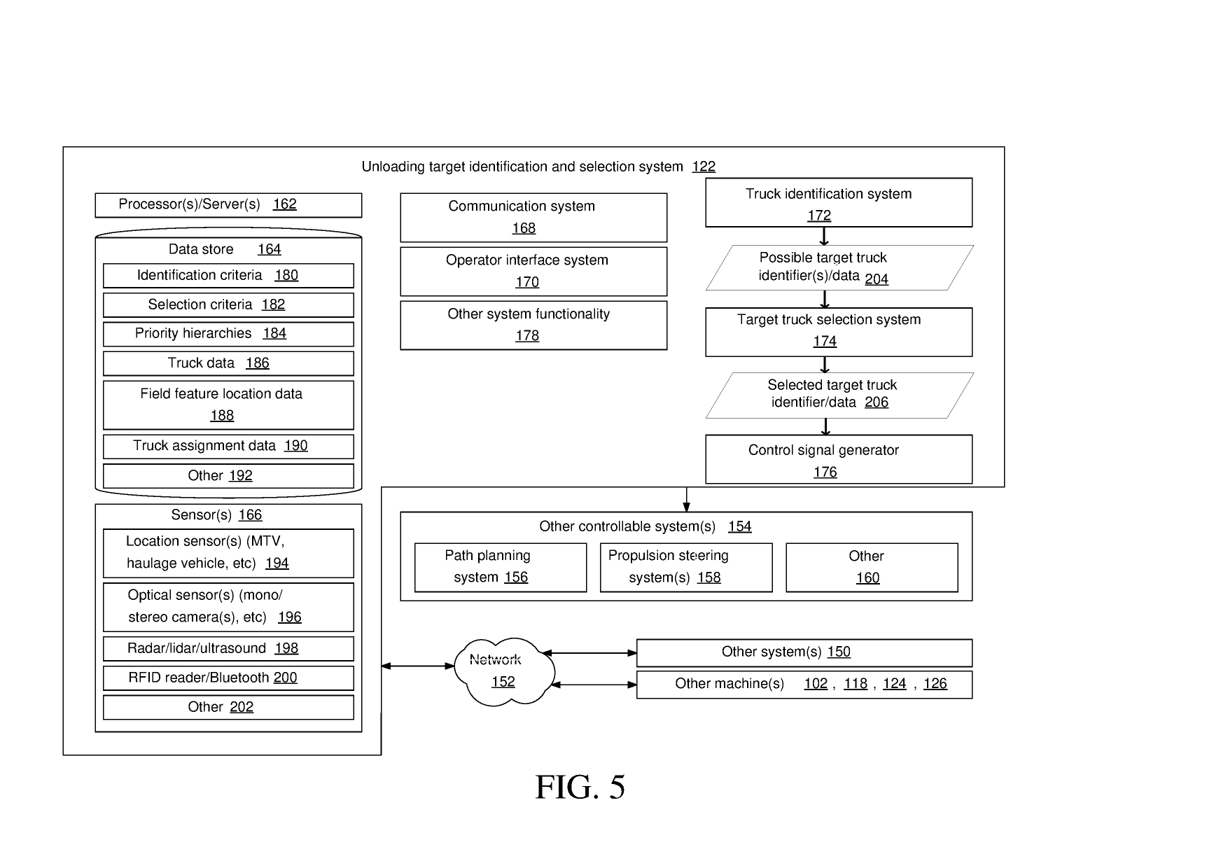

FIG. 5 is a block diagram showing a portion of agricultural system 100, with unloading target identification and selection system 122 shown in more detail. In the example shown in FIG. 5, unloading target identification and selection system 122 is coupled for communication with other machines 102, 118, 124, and/or 126 as well as with other systems 150 over network 152. In one example, network 152 may be a wide area network, a local area network, a cellular communication network, a Wi-Fi or Bluetooth network, a near field communication network, or any of a variety of other networks or combinations of networks. Other systems 150 can include farm manager systems, vendor systems, manufacturer systems, and/or any of a wide variety of other systems. FIG. 5 also shows that unloading target identification and selection system 122 can generate a control signal for controlling one or more controllable systems 154. Controllable systems 154 can include a path planning system 156 which generates a path or route for material transfer vehicle 106, a propulsion/steering system 158 which can propel and steer material transfer vehicle 106, and/or any of a wide variety of other controllable systems.

Unloading target identification and selection system 122, in the example shown in FIG. 5, can include one or more processors or servers 162, data store 164, sensors 166, communication system 168, operator interface system 170, truck identification system 172, truck selection system 174, control signal generator 176, and/or other system functionality 178. Data store 164 can include identification criteria 180, selection criteria 182, priority hierarchies 184, truck data 186, field feature location data 188, truck assignment data 190, and/or any of wide variety of other data 192. Sensors 166 can include location sensors 194 (which may provide the location of material transfer vehicle 106 and/or any of the haulage vehicles 118, 124, and 126), optical sensors 196 (which may include mono or stereo cameras or other optical sensors), one or more radar sensors, lidar sensors, ultrasound sensors 198, and RFID reader 200, and/or any of wide variety of other sensors 202. Before describing the overall operation of unloading target identification and selection system 122, a description of some of the items in unloading target identification and selection system 122 will first be described.

Identification criteria 180 can include a set of criteria that are used by truck identification system 172 to identify haulage vehicles that may be possible target trucks for material transfer vehicle 106. Therefore, the identification criteria 180 can include proximity criteria, such as the proximity of a haulage vehicle to material transfer vehicle 106, the proximity of a haulage vehicle to the field entry/exit point 123, the proximity of a haulage vehicle to an unloading zone, the proximity of a haulage vehicle to the last location where material transfer vehicle 106 unloaded material, among other proximity – based criteria.

Selection criteria 182 may be criteria used by target truck selection system 174 to select a possible target truck as a selected target truck for material transfer vehicle 106. Selection criteria 182 may thus include first-in-first-out (FIFO) criteria indicative of which of the haulage vehicles has been in the field the longest, location-based criteria, such as which of the haulage vehicles is in the unloading zone, accessibility criteria indicative of which of the haulage vehicles is physically accessible by the material transfer vehicle 106, truck-specific capacity criteria indicative of the remaining capacity in a haulage vehicle as well as the amount of material being carried by material transfer vehicle 106, operator preference criteria such as whether haulage vehicles may be higher priority given operator preferences, among other criteria.

Priority hierarchies 184 may arrange the truck identification criteria and/or truck selection criteria according to a priority hierarchy. Therefore, when different haulage vehicles meet different criteria, the haulage vehicles can still be identified and selected based upon which of those criteria are higher in a priority hierarchy.

Truck data 186 may include a truck identifier which uniquely identifies a haulage vehicle, or which identifies a type of truck, the capacity of the truck, the dimensions of the truck, and/or any of a wide variety of other data corresponding to an individual truck or an individual type of truck.

Field feature location data 188 may identify the location of various features in field 125, such as the location of the entry/exit point 123, the location of loading zone 132, and/or the location of other features in field 125.

Truck assignment data 190 illustratively tracks which of the available haulage vehicles have already been assigned to a material transfer vehicle. Thus, even if a haulage vehicle is higher priority according to the truck selection criteria, it may not be the selected target truck because it is already assigned to receive material from a different material transfer vehicle.

Location sensor 194 senses the position of the vehicle to which sensor 194 is mounted in a global or local coordinate system. Therefore, location sensor 194 may be a Global Navigation Satellite System (GNSS) receiver, a cellular triangulation system, a dead reckoning system, or any of a wide variety of other positioning systems.

Optical sensors 196 may be mounted on material transfer vehicle 106, or elsewhere, and capture an image. The image may be a static image or a video image. Optical sensors 196 may thus be a mono camera, stereo camera, or other cameras that capture one or more static or video images, as well as image processing functionality that processes the captured images and generates an output indicative of items identified in the images, the locations of those items, etc. Additional or different optical sensors and image processing can be provided as well.

Radar/lidar/ultrasound sensors 198 may also be mounted on material transfer vehicle 106, or elsewhere, to detect objects in the field of view of sensors 198. The output from one or more of the sensors 198 can be processed to identify the location or distance of a sensed object relative to material transfer vehicle 106 or relative to another item.

RFID reader 200 (including inactive and active (e.g., Bluetooth) RFID devices) may be mounted on material transfer vehicle 106 to read an RFID tag mounted on haulage vehicles 118, 124, and/or 126. Other sensors 202 can be provided as well.

Communication system 168 illustratively enables communication of the various items in agricultural system 100 with respect to one another. Therefore, communication system 168 may be a controller area network (CAN) bus and bus controller, a communication system that facilitates communication over network 152, such as a cellular communication system, a near field communication system, a Bluetooth or Wi-Fi communication system, a wide area network communication system, local area network communication system, or any of a variety of other communication systems or combinations of systems.

Operator interface system 170 includes interface mechanisms that can be used by an operator. The operator may be a manual operator, an automated operator, or a semi-automated operator. The operator interface mechanisms in operator interface system 170 can include a steering wheel, joysticks, levers, pedals, knobs, buttons, or other input mechanisms. Further, the interface mechanisms can include a display screen that displays information on interfaces for the operator and may receive inputs from the operator. For instance, a display may include actuatable elements such as icons, links, buttons, etc. The display screen may be a touch sensitive display screen and the interface mechanisms may also include voice-related mechanisms, such as a microphone, speaker, speech synthesis functionality, speech recognition functionality, among other things. Thus, the actuatable elements may be actuated by operator 128 using a point-and-click device, touch gestures, voice commands, etc.

Truck identification system 172 identifies that there are a plurality of haulage vehicles that may be available to receive material from material transfer vehicle 106. Truck identification system 172 identifies the plurality of haulage vehicles and generates an output 204 identifying possible target trucks, along with data corresponding to each possible target truck. The data may include the type of truck, the capacity of the truck, the remaining capacity of the truck if the truck is partially loaded, the location of the truck, the location of the truck relative to the material transfer vehicle, relative to field features, relative to a loading zone, etc. Truck identification system 172 can process the identification criteria 182 and generate the output 204.

Target truck selection system 174 receives output 204 from truck identification system 172 and selects one of the possible target trucks as the selected target truck for material transfer vehicle 106. Target truck selection system 174 can process the selection criteria 182 to generate an output 206 identifying the target truck, along with data corresponding to the target truck, such as its location, its location relative to material transfer vehicle 106, visual indicia which make visual identification of the target truck easier, and/or any of wide variety of other information.

Control signal generator 176 receives, as an input, the output 206 from target truck selection system 174 identifying the selected target truck and generates a control signal based upon that input. The control signal can be used to control communication system 168 to communicate with the operator of the target truck to move the target truck into the loading zone 132, or to convey other information. The control signal can also be used to control a path planning system 156 to generate a path or route for material transfer 106 to the target truck. The control signal can be used to control a propulsion/steering subsystem 158 on material transfer vehicle 106 to automatically navigate material transfer vehicle 106 to the target truck and/or to automatically perform an unloading operation. By “automatically” it is meant, in one example, that the process or function or step is performed without further human involvement except, perhaps, to initiate or authorize the process, function., or step.

One example of a propulsion/steering system 158 may include one or more steering actuators and an internal combustion engine, an electric motor, a transmission, individual drive motors, or other devices that can be used to generate propulsion and steering of propulsion vehicle 108.

Path planning system 156 can use occupancy grid maps or other representations to discretize space over which a route is being planned. Path planning system 156 can include the Dijkstra algorithm, A* or D* algorithms, and/or any of a wide variety of other algorithms. These and other algorithms can be run using machine learning models, artificial neural networks, artificial intelligence (AI) generative models, and/or any of a wide variety of other path planning models or algorithms. The path or route generated by path planning system 156 can be used by a navigation system to automatically or semi-automatically navigate the material transfer vehicle to the target truck and perform an unloading operation. Similarly, the route or path generated by path planning system 156 can be surfaced for a human operator on a user interface so that the human operator can navigate the material transfer vehicle based upon the path.

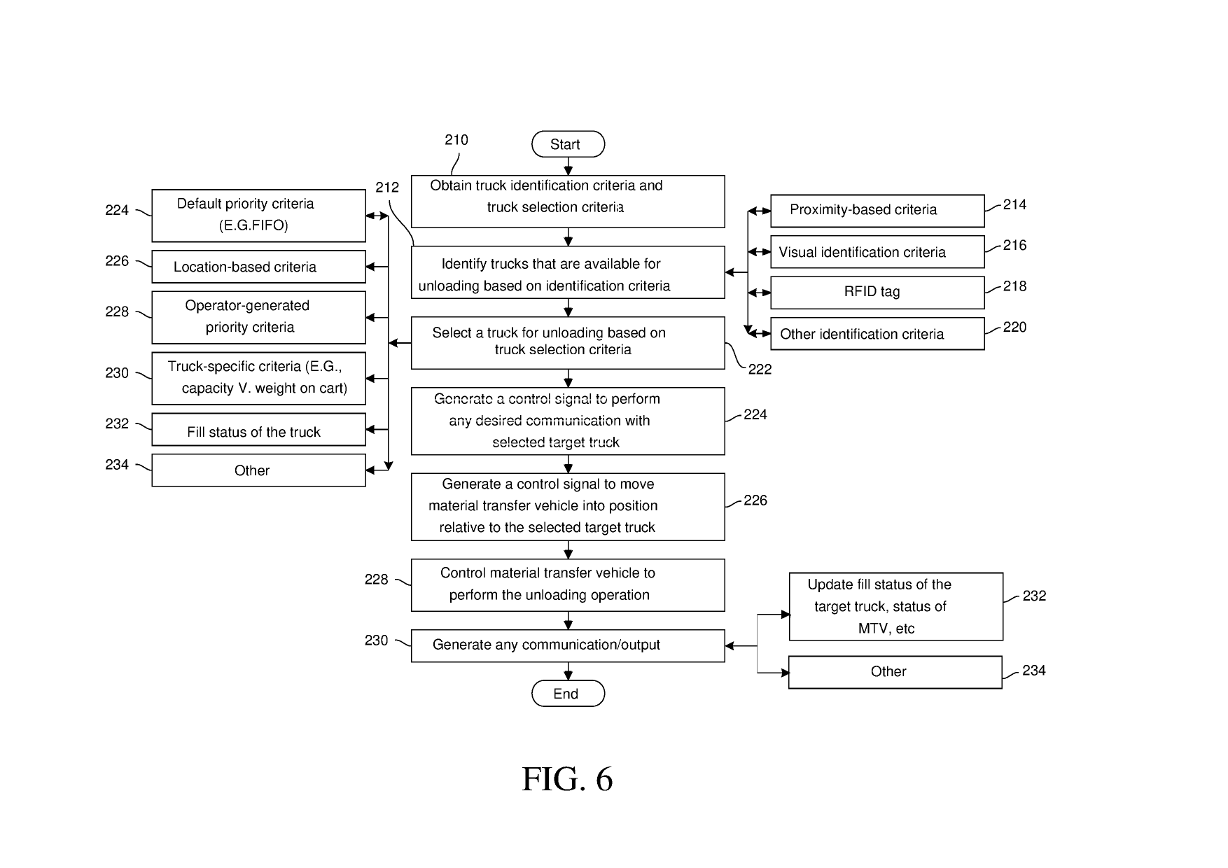

FIG. 6 is a flow diagram illustrating one example of the operation of unloading target identification and selection system 122. It is first assumed that truck identification system 172 accesses or otherwise obtains the truck identification criteria 180 and that target truck selection system 174 accesses or otherwise obtains the selection criteria 182. Obtaining the target truck identification criteria 180 and the target truck selection criteria 182 is indicated by block 210 in the flow diagram of FIG. 6.

Truck identification system 172 then identifies trucks that are available for unloading, and that may be selected as a target truck, based upon the identification criteria 180, as indicated by block 212 in the flow diagram of FIG. 6. The identification criteria 180 may include such things as proximity-based criteria 214, visual identification criteria 216, RFID tag information that is read from an RFID tag, and/or any of a wide variety of other truck identification criteria 220. The possible target truck identifiers and data 204 are then output to target truck selection system 174 which processes the selection criteria 182 and selects a truck for unloading based upon the truck selection criteria 182. The selected truck may also be referred to herein as a selected target truck. Selecting a truck for unloading is indicated by block 222 in the flow diagram of FIG. 6. The selection criteria 182 may include default priority criteria 224 (such as FIFO criteria), location-based criteria 226, operator-generated priority criteria 228, truck-specific criteria 230 (such as truck capacity relative to the quantity of material in grain cart 110), the fill status of the truck or haulage vehicle 232, and/or any of wide variety of other truck selection criteria 234.

The selected truck identifier and corresponding data 206 is provided to control signal generator 176. Control signal generator 176 can generate a control signal to control communication system 168 to perform any desired communication with the selected haulage vehicle (or the selected target truck), as indicated by block 224 in the flow diagram of FIG. 6. The communication system 168 may be controlled to communicate with an operator of the selected target truck. A control signal can be generated to automatically control the selected target truck to move into an unloading zone 132 or to another desired location.

Control signal generator 176 then generates a control signal to move material transfer vehicle 106 into position relative to the selected target truck to perform an unloading operation as indicated by block 226 in the flow diagram of FIG. 6. The control signal may be to generate a display or another output for an operator of material transfer vehicle 106 so that the operator can control the material transfer vehicle 106 to move to the selected target truck. The control signal may be to automatically control the path planning system 156 to generate a route or path for material transfer vehicle 106 to approach the selected target truck. The control signal may be to automatically control propulsion/steering system 158 on material transfer vehicle to automatically navigate the material transfer vehicle 106 into position to perform an unloading operation into the target truck. Once in the proper position, material transfer vehicle 106 is controlled to perform the unloading operation to unload harvested material from grain cart 110 into the target truck as indicated by block 228 in the flow diagram of FIG. 6. Again, material transfer vehicle 106 can be controlled automatically, semi-automatically, or manually.

Control signal generator 176 can also generate other control signals to perform other communications once the unloading operation is complete, as indicated by block 230 in the flow diagram of FIG. 6. The control signals can be used to communicate or store a value indicative of the updated fill status of the target truck, the remaining capacity of the target truck, the remaining material in grain cart 110 (if there is any material remaining), among other outputs. Generating such outputs as indicated by block 232 in the flow diagram of FIG. 6. Control signal generator 176 can generate any of a wide variety of other communications or outputs as indicated by block 234.

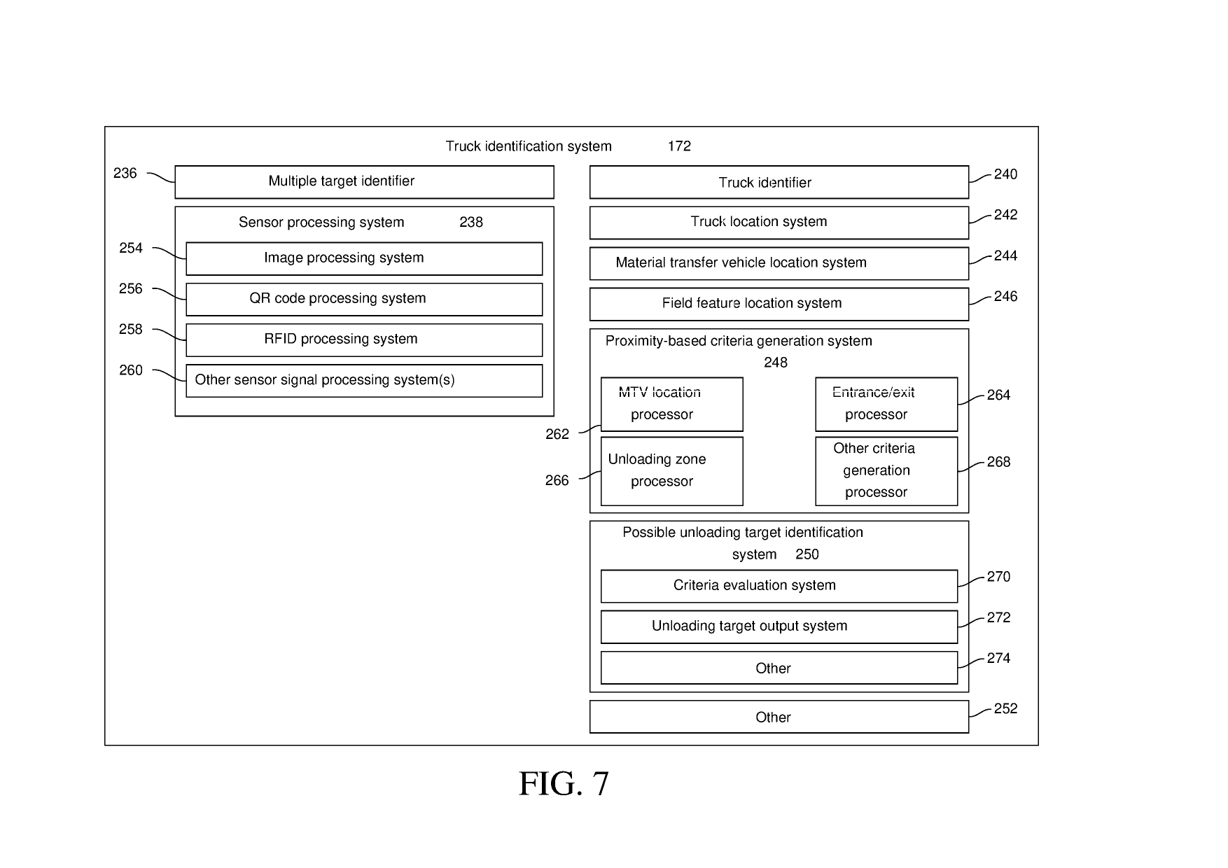

FIG. 7 shows a block diagram of one example of truck identification system 172 in more detail. In the example shown in FIG. 7, truck identification system 172 includes multiple target identifiers 236, sensor processing system 238, truck identifier 240, truck location system 242, material transfer vehicle location system 244, field feature location system 246, proximity – based criteria generation system 248, possible unloading target identification system 250, and any of wide variety of other functionality 252. Sensor processing system 238 can include image processing system 254, QR code processing system 256, RFID processing system 258, and other sensor signal processing systems 260. Proximity-based criteria generation system 248 can include material transfer vehicle location processor 262, entrance/exit processor 264, unloading zone processor 266, and other criteria generation processor 268. Possible unloading target identification system 250 can include criteria evaluation system 270, unloading target output system 272, and other items 274. Before describing the overall operation of truck identification system 172 in more detail, a description of some of the items in truck identification system 172, and their operation, will first be provided.

Sensor processing system 238 receives inputs from sensors 166 and processes those inputs to generate outputs. Image processing system 254 may thus receive an input from one or more optical sensors 196 and generate an output indicative of items recognized in the images captured by optical sensors 196. QR code processor 256 may receive an input from optical sensor 196 indicative of a QR code and generate an output based upon the QR code that is scanned in the image captured by optical sensors 196. RFID processing system 258 can receive an input from RFID reader 200 and generate an output based upon that input. Other sensor signal processing systems 260 can receive inputs from radar/lidar/ultrasound sensors 198 and other sensors 202 and generate outputs based on the sensor signals received.

Multiple target identifier 236 identifies when there are a plurality of different possible target vehicles that may be selected as target trucks for material transfer vehicle 106. For example, multiple target identifier 236 may receive an input from one or more of the sensors 238 and determine that there are a plurality of possible target vehicles available for selection. For instance, image processing system 254 may generate an output indicative of truck identifiers that are displayed on the hoods or operating compartments or sides of the haulage vehicles 118, 124, and 126. Based upon those identifiers, multiple target identifier 236 can generate an output indicating that there are multiple possible target trucks. Image processing system 254 may also generate an output identifying two or more haulage vehicles in an image captured of field 125 proximate and unloading zone 132. Based upon the plurality of haulage vehicles identified in the image, multiple truck identifier 236 may generate an output indicating that there are a plurality of possible target trucks. Further, each of the haulage vehicles 118, 124, and 126, may communicate over communication system 168 by sending a message identifying the haulage vehicle from which the message originated. For instance, haulage vehicle 118 may send a message with truck identifying information identifying haulage vehicle 118. Haulage vehicle 124 may send a similar message, as may haulage vehicle 126. Based upon those messages, multiple target identifier 236 may generate an output indicating that there are multiple possible target trucks.

Truck identifier 240 identifies the specific haulage vehicles 118, 124, and 126 that are possible target trucks. For instance, truck identifier 240 can receive an indication of the identity of the truck from multiple target identifier 236, from an image processed by image processing system 254, from a QR code that may be displayed on the side of a haulage vehicle and read by QR code processing system 256, an identifier received from RFID processing system 258, or other truck-specific identifiers. Further, truck identifier 240 may compare an image of a truck output by image processing system 254 against a library of images of trucks to match the image of the truck in field 125 against one of the images in the library. When a matching truck is found, then the truck identifier 240 may obtain the identity of the matching truck. Truck identifier 240 generates an output indicative of the identity of the different haulage vehicles 118, 124, and 126 that may be possible target trucks for material transfer vehicle 106.

Truck location system 242 generates an output indicative of the location of each of the identified trucks identified by truck identifier 240. Truck location system 242 may thus receive from a haulage vehicle an indication of the location of that haulage vehicle (e.g., the coordinates of the haulage vehicle in a local or global coordinate system) and identify the truck location based upon the received input. Truck location system 242 may also process the inputs from radar/ lidar/ultrasound sensors 198 to identify the location of each of the haulage vehicles relative to the material transfer vehicle 106. Truck location system 242 may also perform image processing to identify the location of the haulage vehicles relative to material transfer vehicle 106 based upon the captured images. For example, by knowing the orientation of the optical sensor 196 on material transfer vehicle 106, an image of a haulage vehicle captured by optical sensor 196 may be processed to identify the direction and distance of that haulage vehicle relative to material transfer vehicle 106. Truck location system 242 can identify the locations of the various haulage vehicles in other ways as well.

Material transfer vehicle location system 244 then identifies the location of material transfer vehicle 106. The location of material transfer vehicle 106 may be output by location sensor 194 or identified in other ways.

Field feature location system 246 identifies the location of field features, such as entry/exit point 123, loading zone 132, or other features. The location of those features may be read from a map, may be input by an operator, or may be obtained from images processed by image processing system 254, or in other ways.

Proximity-based criteria generation system 248 then generates values for the identification criteria 180 that are to be used in identifying possible target trucks for material transfer vehicle 106. Material transfer vehicle location processor 262 calculates the distance between material transfer vehicle 106 and each of the haulage vehicles. Processor 262 may also calculate the direction of the haulage vehicles relative to material transfer vehicle 106. Entry/exit processor 264 calculates the distance between each of the haulage vehicles and the entry/exit point 123. Unloading zone processor 266 calculates whether any of the haulage vehicles are in the unloading zone 132 and/or the distance that each of the haulage vehicles is from the unloading zone 132. Other criteria generation processor 268 can generate values for other identification criteria 180 as well.

The values for the identification criteria 180 are then provided to possible unloading target identification system 250. Criteria evaluation system 270 evaluates the criteria values to determine whether a haulage vehicle is a possible target truck for material transfer vehicle 106. For instance, the identification criteria may be compared against a priority hierarchy 184 to determine whether a particular haulage vehicle is a possible target truck for material transfer vehicle 106. In another example, the values for each of the identification criteria may be aggregated to identify an overall score for each haulage vehicle to determine whether a particular haulage vehicle is a possible target truck for material transfer vehicle 106. The identification criteria 180 can be evaluated in other ways as well.

Based upon the output from criteria evaluation system 270, unloading target output system 272 generates the possible target truck identifiers and data 204 which identify each of the plurality of haulage vehicles 118, 124, and 126 that are possible target trucks for material transfer vehicle 106, along with any additional data corresponding to those haulage vehicles.

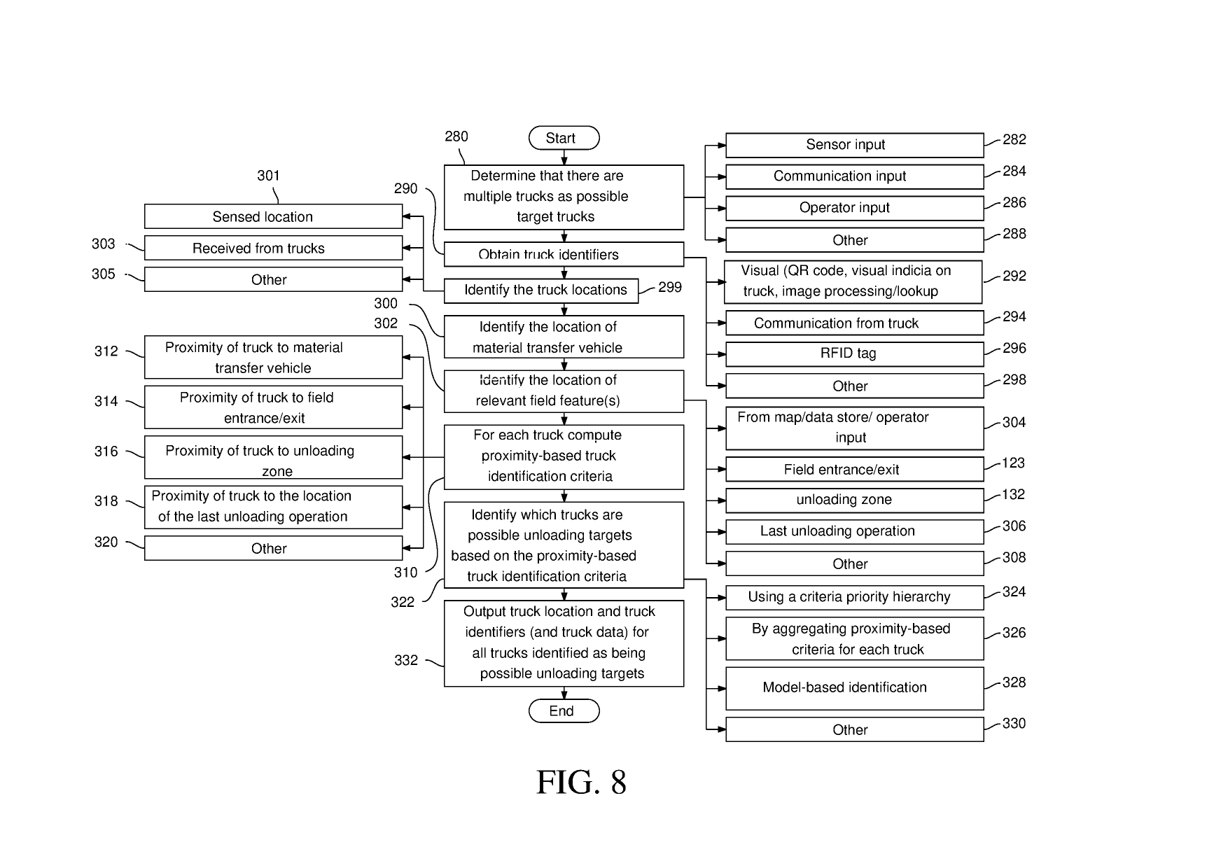

FIG. 8 is a flow diagram illustrating one example of the operation of truck identification system 172 in more detail. It is first assumed that multiple target identifier 236 has determined that there are multiple trucks which may be possible target trucks for material transfer vehicle 106. Determining that there are multiple target trucks is indicated by block 280 in the flow diagram of FIG. 8. That determination can be made based on inputs from sensors 166 and from sensor processing system 238, as indicated by block 282. The determination that there are a plurality of possible target trucks can be based on a communication input from the haulage vehicles themselves, as indicated by block 284, or based on operator input, as indicated by block 286. The determination that there are a plurality of possible target trucks can be made in other ways, based on other criteria as well, as indicated by block 288.

Truck identifier 240 then obtains or generates or identifies the identifiers corresponding to each of the plurality of possible target trucks, as indicated by block 290 in the flow diagram of FIG. 8. The truck identifiers can be obtained through visual observation (such as reading a QR code, identifying visual indicia on the truck by performing image processing, comparing an image of the truck against a library of truck images, or in other ways) as indicated by block 292. The truck identifiers can be obtained by receiving a communication from each of the individual haulage vehicles, themselves, as indicated by block 294. The truck identifiers can be obtained by reading an RFID tag on the haulage vehicle, as indicated by block 296, or in other ways, as indicated by block 298.

Truck location system 242 identifies the location of each of the haulage vehicles, as indicated by block 299 in FIG. 8. The locations of the haulage vehicles can be sensed by sensors 166 as indicated by block 301, or the locations can be received from the haulage vehicles themselves, as indicated by block 303. For example, each of the haulage vehicles may have a location sensor 194 which senses its location and outputs that location to material transfer vehicle 106 using communication system 168. The locations of the haulage vehicles may be relative to material transfer vehicle 106 or absolute locations. The locations of the haulage vehicles can be obtained in other ways as well, as indicated by block 305.

Material transfer vehicle location system 244 then identifies the location of the material transfer vehicle 106, as indicated by block 300. The location can be obtained from the location sensor 194 on material transfer vehicle 106 or in other ways.

Field feature location system 246 then identifies the locations of any relevant field features, as indicated by block 302. Field feature location system 246 can access a map, a data store, or receive an operator input identifying the locations of the field features, as indicated by block 304. The field features may include such things as field entrance/exit point 123, unloading zone 132, the geographic location where material transfer vehicle 106 last performed in unloading operation, as indicated by block 306, or in a wide variety of other ways, as indicated by block 308.

Then, for each haulage vehicle that may be a possible target truck for material transfer vehicle 106, proximity-based criteria generation system 248 computes the proximity-based truck identification criteria, as indicated by block 310. MTV location processor 262 computes the proximity of each of the haulage vehicles relative to the material transfer vehicle 106, as indicated by block 312 and the flow diagram of FIG. 8. Entrance/exit processor 264 then computes the proximity of each of the haulage vehicles relative to the field entrance/exit point 123, as indicated by block 314. Unloading zone processor 266 computes the proximity of each of the haulage vehicles relative to unloading zone 132, as indicated by block 316 in the flow diagram of FIG. 8. Unloading zone processor 266 may also compute the proximity of each of the haulage vehicles relative to the location where material transfer vehicle 106 last performed in unloading operation in field 123, as indicated by block 318 in the flow diagram of FIG. 8. Other criteria generation processor 268 can compute any of a wide variety of other truck identification criteria as well, as indicated by block 320.

The criteria computed by proximity-based criteria generation system 248 are provided to criteria evaluation system 270 which evaluates those criteria and identifies which of the haulage vehicles are possible unloading targets for material transfer vehicle 106, as indicated by block 322 in the flow diagram of FIG. 8. The criteria can be evaluated using a criteria priority hierarchy which ranks the importance of the criteria according to a hierarchy. Using a criteria priority hierarchy is indicated by block 324 in the flow diagram of FIG. 8. Criteria evaluation system 270 may aggregate the criteria for each haulage vehicle to compute an overall score corresponding to each haulage vehicle and then use that score to determine whether the corresponding haulage vehicle is a possible target truck for material transfer vehicle 106. Aggregating the proximity-based criteria for each truck is indicated by block 326 in the flow diagram of FIG. 8. Criteria evaluation system 270 may evaluate the criteria using an algorithm or using a model or using another mechanism, as indicated by block 328. Different proximity-based truck identification criteria can be used and evaluated in other ways, as indicated by block 330.

Unloading target output system 272 then generates an output 204 which identifies the possible target truck trucks and corresponding data (such as the locations and truck identifiers as well as other possible data, such as the truck capacity, configuration, etc.) for all of the trucks that have been identified as being possible unloading targets for material transfer vehicle 106. The data output for each possible unloading target may also include a visual identifier so that each possible target truck can be easily identified visually, or other data, as indicated by block 332 in the flow diagram of FIG. 8.

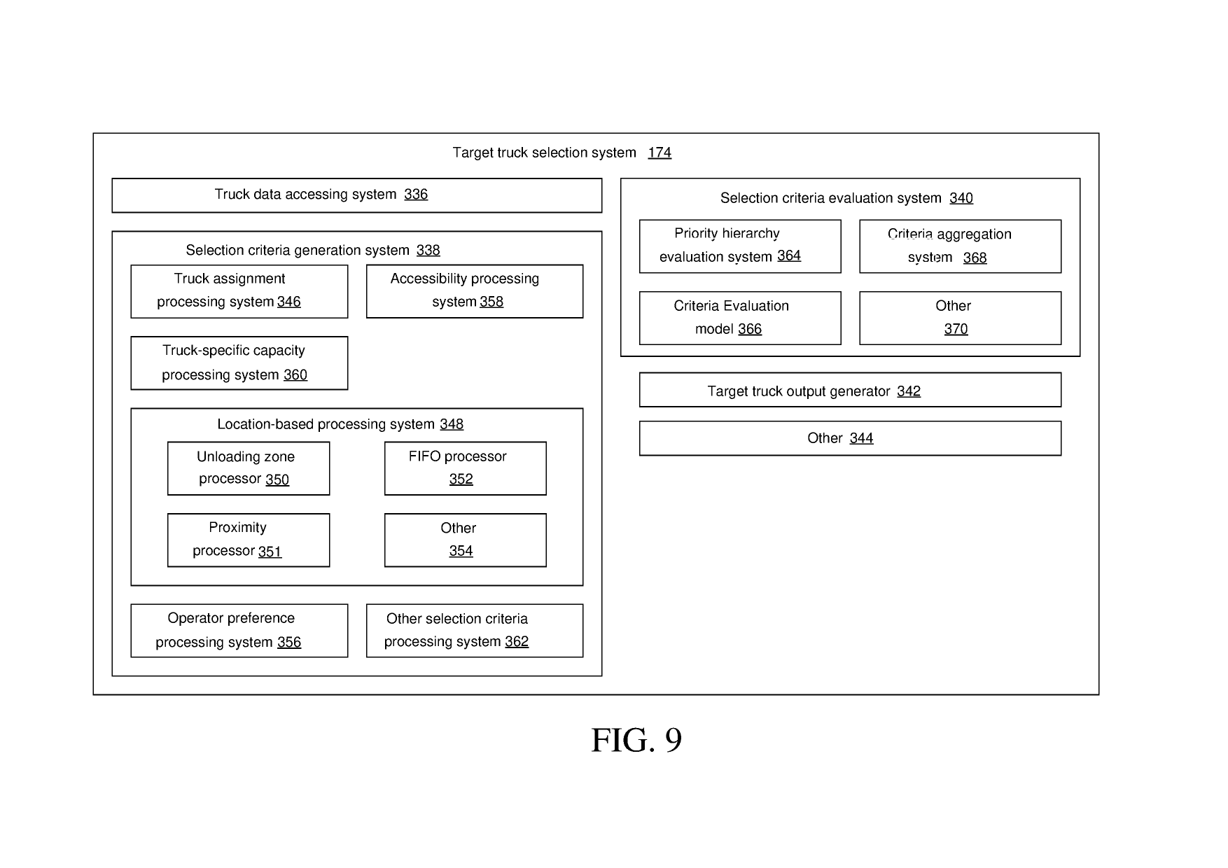

FIG. 9 is a block diagram showing one example of target truck selection system 174 in more detail. In the example shown in FIG. 9, target truck selection system 174 includes target data accessing system 336, selection criteria generation system 338, selection criteria evaluation system 340, target truck output generator 342, and other items 344. Selection criteria generation system 338 includes truck assignment processing system 346, location-based processing system 348 (which, itself, includes unloading zone processor 350, proximity processor 351, FIFO processor 352, and other items 354), operator preference processing system 356, accessibility processing system 358, truck-specific capacity processing system 360, and other selection criteria processing system 362. Selection criteria evaluation system 340 can include priority hierarchy evaluation system 364, criteria evaluation model 366, criteria aggregation system 368, and other items 370. Before describing the operation of target truck selection system 174 in more detail, a description of some of the items in target truck selection system 174, and their operation, will first be provided.

Truck data accessing system 336 can access any of the data from data store 164 or from other systems 150 or elsewhere. Thus, truck data accessing system 336 obtains selection criteria 182, any priority hierarchies 184, truck data 186, field feature location data 188, truck assignment date at 190, etc.

Selection criteria generation system 338 then generates values for the selection criteria 182 that will be used to select the target truck for material transfer vehicle 106. Truck assignment processing system 346 analyzes the truck assignment data 190 to see whether any of the possible target trucks are already assigned to a different material transfer vehicle. If so, such trucks can be eliminated as possible target trucks for material transfer vehicle 106. Location-based processing system 348 generates values for location-based criteria which may be used in selecting the target truck. Unloading zone processor 350 determines whether any of the possible target trucks are in the unloading zone 132, or which of the possible target trucks is closest to the unloading zone 132. Proximity processor 351 may identify which of the possible target trucks is closest to material transfer vehicle 106. FIFO processor 352 may process the locations of the possible target trucks to identify which possible target truck is closest to the field entry selection exit point 123, in order to establish a FIFO order among the possible target trucks. For instance, the possible target truck that is closest to the entry/exit point 123 may be the target truck that first entered the field, among the possible target trucks.

Operator preference processing system 356 processes any operator preference selection criteria. For instance, the operator may enter a preference indicating that a possible target truck that has the longest round-trip distance to its destination (e.g., to an elevator) may be preferred over possible target trucks that have shorter round-trip distances. In addition, some of the possible target trucks may be operated by different organizations. The operator may specify a preference for which possible target truck should be selected, based upon the organization responsible for operating that target truck.

Accessibility processing system 358 processes the data corresponding to the possible target trucks to determine whether any of those possible target trucks are inaccessible. For instance, as shown in FIG. 3, it may be that one of the possible target trucks 118 is parked so closely adjacent the other possible target truck 126 that it renders the possible target truck 126 inaccessible to material transfer vehciel106. In that case, only the possible target truck 118 may be selected.

Truck-specific capacity processing system 360 may process the truck data to identify the remaining capacity in any of the possible target trucks and determine whether the amount of material in material transfer vehicle 106 can fit into any of the possible target trucks based on the remaining capacity. Similarly, based upon the amount of material in material transfer vehicle 106, a possible target truck with a closest matching capacity may be selected as the target truck. Truck-specific capacity processing system 360 generates an output indicative of these types of criteria.

Selection criteria evaluation system 340 then selects one of the possible target trucks as the selected target track based upon the criteria values output by selection criteria generation system 338. Priority hierarchy evaluation system 364 can evaluate the selection criteria against a priority hierarchy 184, where a priority hierarchy 184 is available to be used. The priority hierarchy 184 may order the different selection criteria in a priority hierarchy. Thus, the selection criteria ordered higher in the priority hierarchy will be more influential on which possible target truck is selected.

Criteria evaluation model 366 receives the various selection criteria values generated by selection criteria generation system 338 as model inputs. The criteria evaluation model 366 then generates an output indicative of the selected target truck based upon those inputs. Criteria evaluation model 366 may be an artificial neural network, and artificial intelligence generative model, a rules-based classifier, or another type of generative model or classifier, or other machine learned model.

Criteria aggregation system 366 may aggregate the various selection criteria generated by selection criteria generation system 338 and generate an output indicative of the selected target truck based upon that aggregation. For instance, the values of the various selection criteria may be normalized and output by selection criteria generation system 338. Then, the values of the selection criteria generated for each possible target truck may be aggregated (such as averaged, summed, combined in a weighted manner, or aggregated in another way). The possible target truck with the highest scoring aggregated value may be selected as the target truck. Criteria aggregation system 368 may be a rules-based aggregation system, a mathematical or other aggregation algorithm, a model, or another type of aggregation system.

Selection criteria evaluation system 340 generates an output to target truck output generator 342. Target truck output generator 342 generates an output indicative of the selected target truck to control signal generator 176 (shown in FIG. 5). Target truck output generator 342 may generate the output identifying the target truck using an identifier, using visual indicia, or in other ways. Target truck output generator 342 may also just generate the output to indicate the location of the target truck, the location of the target truck relative to material transfer vehicle 106, the location of the target truck relative to the unloading zone 132 or relative to the entry/exit point 123 or using other information.

As discussed above, control signal generator 176 can generate a variety of different outputs or control signals based upon receiving the identity of the selected target truck. Control signal generator 176 may generate an output on operator interface system 170 for the operator of material transfer vehicle 106. The output may display the location of the selected target truck, a visual representation of the selected target truck, a route to the selected target truck, and/or any of wide variety of other information. Control signal generator 176 may generate a control signal to control communication system 168 to communicate with the operator of the selected target truck. That communication may instruct the operator to move the selected target truck to a specific location, such as to move the selected target truck into the unloading zone 132 or elsewhere. The control signal can be a signal to control path planning system 156 to plan a path for the material transfer vehicle 106 based on the location of the selected target truck. The control signal can be an output to control propulsion/steering subsystem 158 on the propulsion vehicle 108 of material transfer vehicle 106 to move material transfer vehicle 106 into position to unload material into the selected target truck. The control signal can be any of wide variety of other control signals as well.

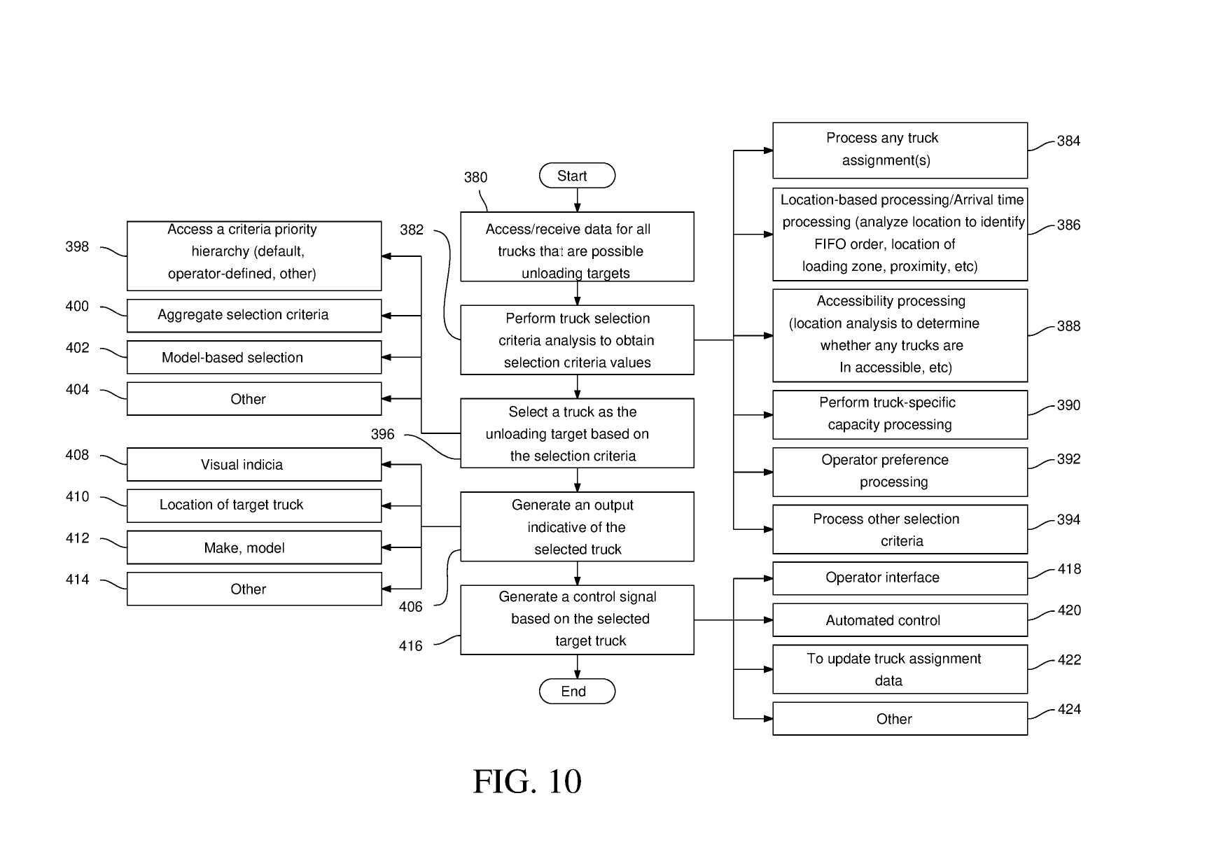

FIG. 10 is a flow diagram illustrating one example of the operation of target truck selection system 174 in more detail. It is first assumed that target truck selection system 174 receives the possible target truck identifiers and data 204 from truck identification system 172, as indicated by block 380 in the flow diagram of FIG. 10. Selection criteria generation system 338 then performs truck selection criteria analysis to obtain values for the selection criteria that are used to select the target truck from among the possible target trucks, as indicated by block 382 in the flow diagram of FIG. 10. Truck assignment processing system 346 processes any truck assignments, as indicated by block 384. Location-based processing system 348 performs processing to analyze the locations of the possible target trucks to identify a FIFO order, to analyze any proximity-based criteria, to analyze criteria related to the location of loading zone 132, or to perform other location-based processing, as indicated by block 386. It will also be noted that FIFO processor 352 can identify the FIFO order of the possible target trucks in other ways. For instance, the possible target trucks may each send a communication indicating the time that the truck entered field 125. This information may be stored along with the truck identifiers and data 204. In that case, FIFO processor 352 can analyze the time data to establish the FIFO order for the possible target trucks. Accessibility processing system 358 performs accessibility processing to determine whether any of the trucks are inaccessible, as indicated by block 388. Truck-specific capacity processing system 360 performs truck-specific capacity processing to determine which trucks have remaining capacity to accommodate the amount of material in material transfer vehicle 106, and other capacity-based processing, as indicated by block 390. Operator preference processing system 356 processes any operator preference-based selection criteria as indicated by block 392. Other selection criteria processing system 362 can process any of wide variety of other selection criteria as well, as indicated by block 394 in the flow diagram of FIG. 10.

Selection criteria evaluation system 340 then evaluates the selection criteria values generated by selection criteria generation system 338 to identify a selected target truck, as indicated by block 396 in the flow diagram of FIG. 10. Priority hierarchy evaluation three system 364 can access a criteria priority hierarchy to identify the selected target truck. The priority hierarchy may be a default hierarchy, and operator-defined hierarchy, or another hierarchy, as indicated by block 398. Criteria aggregation system 368 can aggregate the selection criteria to identify the selected target truck, as indicated by block 400. Criteria evaluation model 366 can receive the selection criteria values as inputs and generate a model output identifying the selected target truck, as indicated by block 402. The target truck can be selected based upon the selection criteria in other ways as well, as indicated by block 404.

Target truck output generator 342 then generates an output indicative of the selected target truck, as indicated by block 406 in the flow diagram of FIG. 10. That output can include visual indicia 412 describing or identifying the target truck as well as the location of the target truck. The output can include the make and model 412 of the target truck, and/or any of wide variety of other data 414.

Control signal generator 176 then generates a control signal based upon receiving the identity of the selected target truck, as indicated by block 416. The control signal can be used to generate an output on operator interface system 170, as indicated by block 418, or an automated control output to control path planning system 156, propulsion/steering system 158, communication system 168, or another controllable system, as indicated by block 420. The control signal can be output to update the truck assignment data 190 show that the material transfer vehicle 106 has now been assigned to the selected target truck, as indicated by block 422. The control signal can be any of wide variety of other control signals 424 as well.

It can thus be seen that unloading target identification and selection system 122 can determine when there is a plurality of possible target trucks available for unloading, and then select one of the possible target trucks as a selected truck, based upon selection criteria. The selection criteria can include any of a wide variety of different types of selection criteria and those criteria can be updated, modified, or incorporated into truck selection in a variety of different ways. A control signal generator can control material transfer vehicle 106 based upon the selected target truck to increase the efficiency of the unloading operation.

The present discussion has mentioned processors and servers. In one example, the processors and servers include computer processors with associated memory and timing circuitry, not separately shown. The processors and servers are functional parts of the systems or devices to which they belong and are activated by and facilitate the functionality of the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, the mechanisms can be actuated using touch gestures. Also, where the device that displays the mechanisms has speech recognition components, the mechanisms can be actuated using speech commands.

A number of data stores have also been discussed. It will be noted the data stores can each be broken into multiple data stores. All can be local to the systems accessing the data stores, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

It will be noted that the above discussion has described a variety of different systems, components, generators, identifiers, models, sensors, and/or logic. It will be appreciated that such systems, components, generators, identifiers, models, sensors, and/or logic can be comprised of hardware items (such as processors and associated memory, or other processing components, some of which are described below) that perform the functions associated with those systems, components, generators, identifiers, models, sensors, and/or logic. In addition, the systems, components, generators, identifiers, models, sensors, and/or logic can be comprised of software that is loaded into a memory and is subsequently executed by a processor or server, or other computing component, as described below. The systems, components, generators, identifiers, models, sensors, and/or logic can also be comprised of different combinations of hardware, software, firmware, etc., some examples of which are described below. These are only some examples of different structures that can be used to form the systems, components, generators, identifiers, models, sensors, and/or logic described above. Other structures can be used as well.

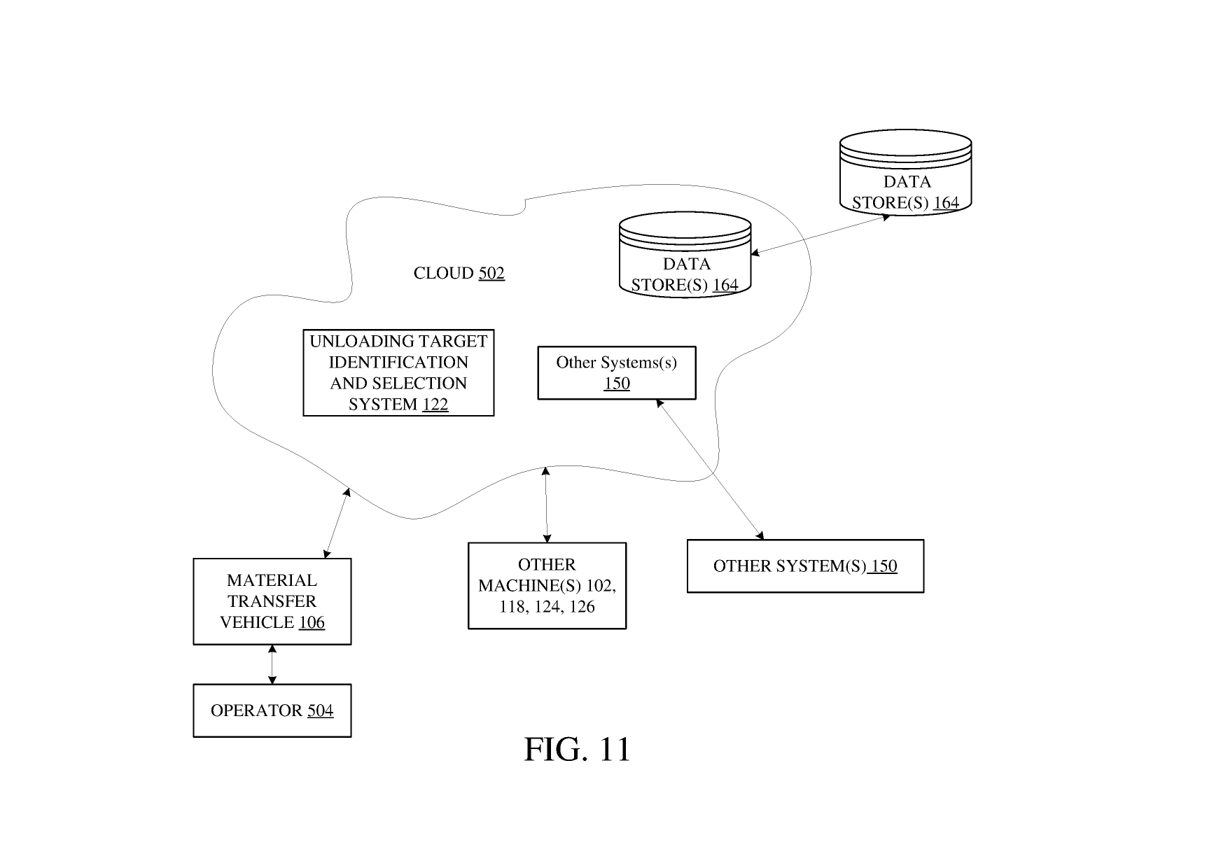

FIG. 11 is a block diagram of agricultural system 100, shown in FIG. 1, except that it communicates with elements in a remote server architecture 500. In an example, remote server architecture 500 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network, and they can be accessed through a web browser or any other computing component. Software or components shown in previous FIGS. as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, the components and functions can be provided from a conventional server, or they can be installed on client devices directly, or in other ways.

In the example shown in FIG. 11, some items are similar to those shown in previous FIGS. and they are similarly numbered. FIG. 11 specifically shows that propulsion system speed control system 122 (or parts of system 122) or data store 164, and/or other systems 150 can be located at a remote server location 502. Therefore, material transfer vehicle 106 accesses those systems through remote server location 502. FIG. 11 shows that some or all of the sensors 166 and/or other material transfer vehicle functionality 504 can be located on material transfer vehicle 106 as well.

FIG. 11 also depicts another example of a remote server architecture. FIG. 11 shows that it is also contemplated that some elements of previous FIGS are disposed at remote server location 502 while others are not. By way of example, other systems 150 and/or data store 164 can be disposed at a location separate from location 502 and accessed through the remote server at location 502. Regardless of where the items are located, they can be accessed directly by material transfer vehicle 106, through a network (either a wide area network or a local area network), the items can be hosted at a remote site by a service, or the items can be provided as a service, or accessed by a connection service that resides in a remote location. Also, the data can be stored in substantially any location and intermittently accessed by, or forwarded to, interested parties. All of these architectures are contemplated herein.

It will also be noted that the elements of previous FIGS., or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

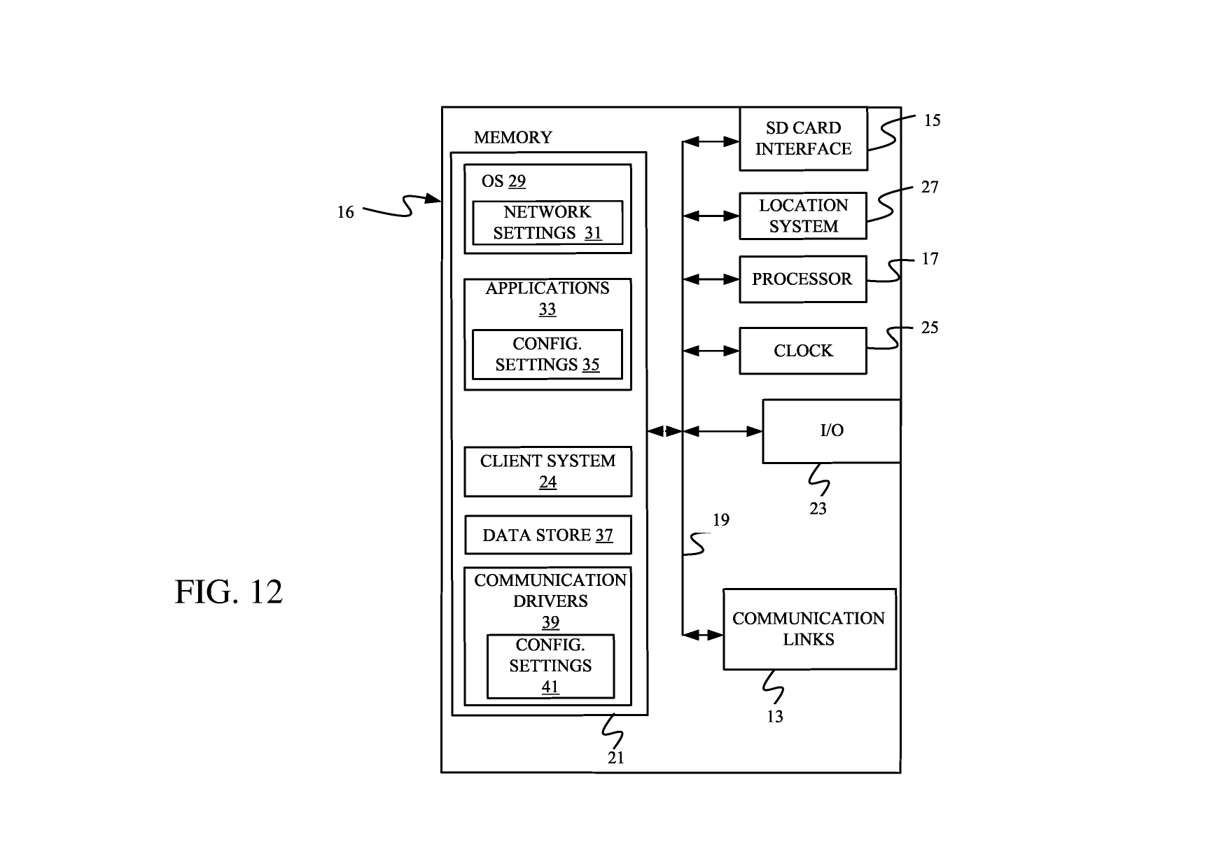

FIG. 12 is a simplified block diagram of one illustrative example of a handheld or mobile computing device that can be used as a user’s or client’s handheld device 16, in which the present system (or parts of it) can be deployed. For instance, a mobile device can be deployed in the operator compartment of propulsion vehicle 108 for use in generating, processing, or displaying the target truck data. FIGS. 12-14 are examples of handheld or mobile devices.

FIG. 12 provides a general block diagram of the components of a client device 16 that can run some components shown in previous FIGS., that interact with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from previous FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

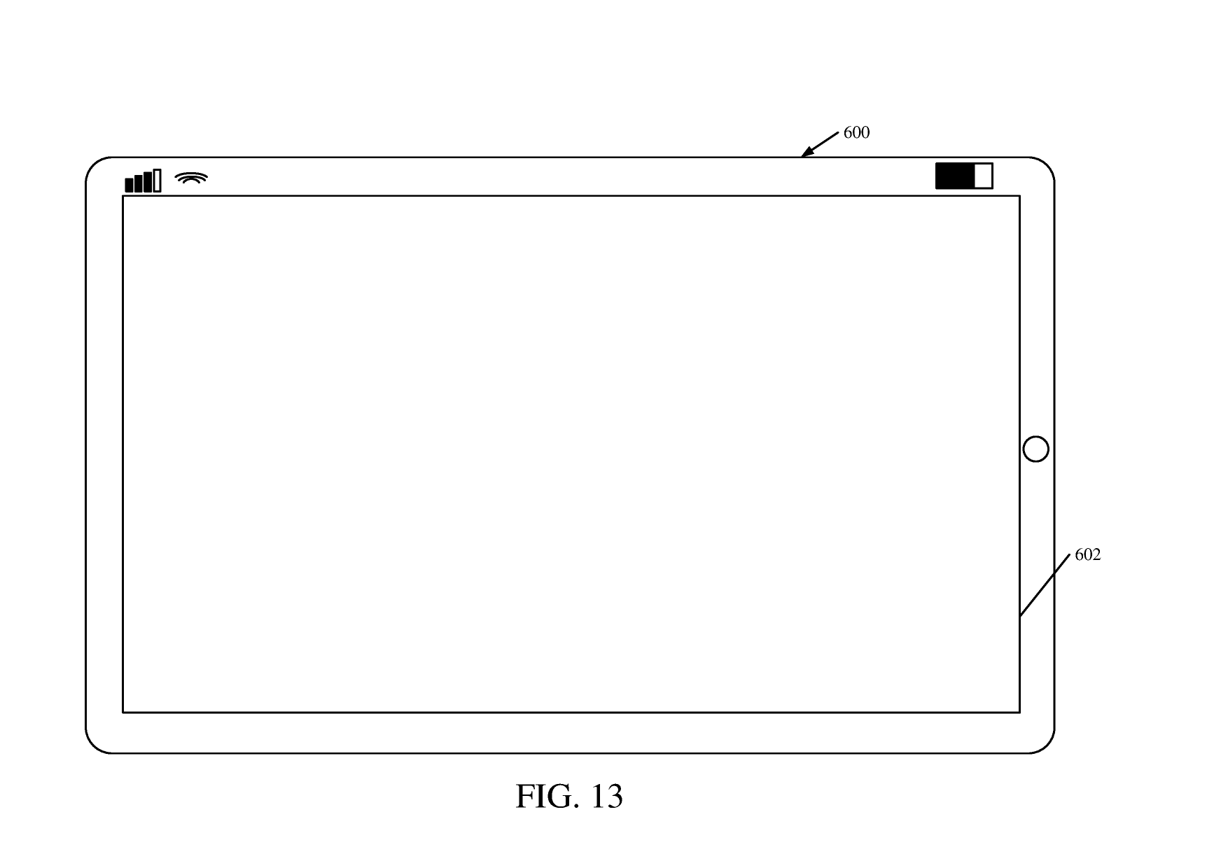

FIG. 13 shows one example in which device 16 is a tablet computer 600. In FIG. 13, computer 600 is shown with user interface display screen 602. Screen 602 can be a touch screen or a pen-enabled interface that receives inputs from a pen or stylus. Computer 600 can also use an on-screen virtual keyboard. Of course, computer 600 might also be attached to a keyboard or other user input device through a suitable attachment mechanism, such as a wireless link or USB port, for instance. Computer 600 can also illustratively receive voice inputs as well.

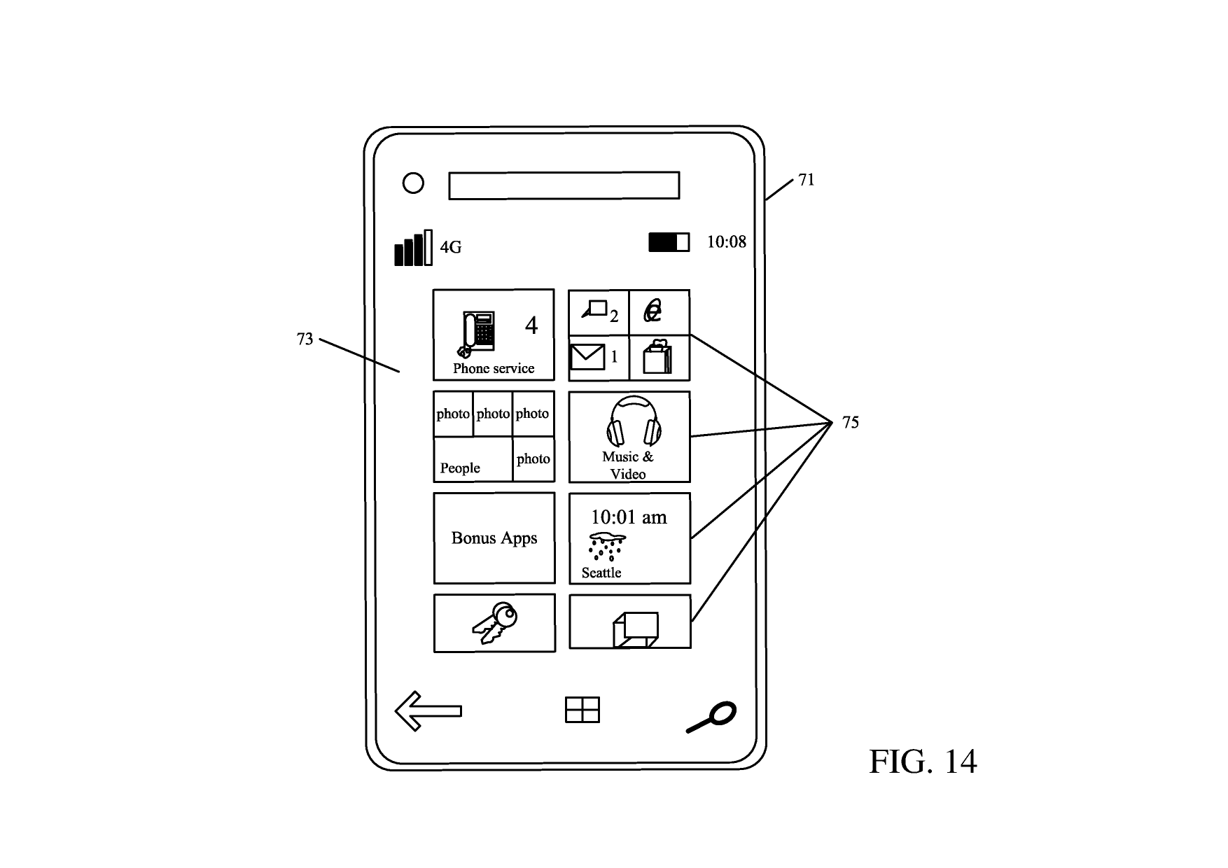

FIG. 14 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

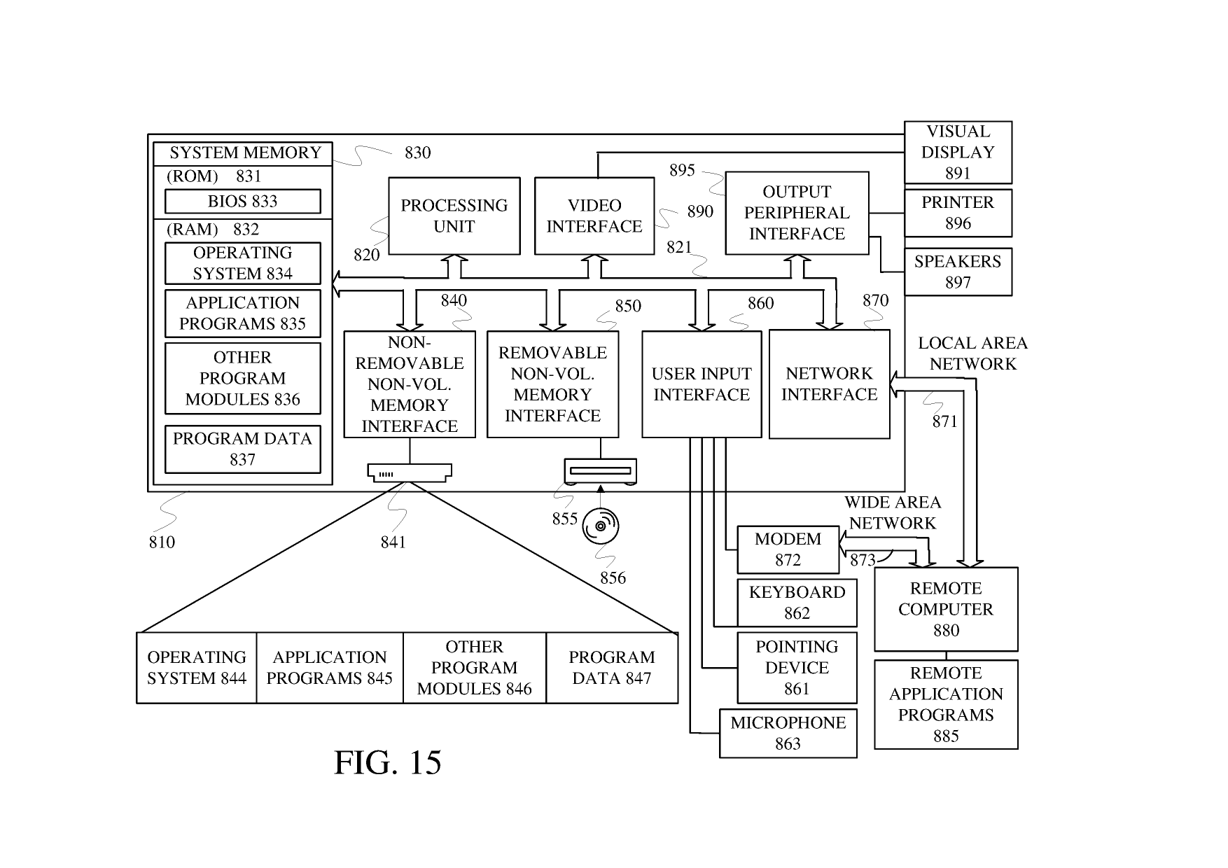

FIG. 15 is one example of a computing environment in which elements of previous FIGS., or parts of it, (for example) can be deployed. With reference to FIG. 15, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to previous FIGS. can be deployed in corresponding portions of FIG. 15.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory such as read only memory (ROM) 831 and random-access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 15 illustrates operating system 834, application programs 835, other program modules 836, and program data 837.

The computer 810 may also include other removable/non-removable volatile/nonvolatile computer storage media. By way of example only, FIG. 15 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 15, provide storage of computer readable instructions, data structures, program modules and other data for the computer 810. In FIG. 15, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a controller area network – CAN, local area network - LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 15 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method, comprising:
automatically detecting a plurality of possible target haulage vehicles are available to receive harvested material from a material transfer vehicle;
automatically selecting a selected target haulage vehicle, of the plurality of possible target haulage vehicles, to receive harvested material from the material transfer vehicle; and
generating a control signal based on the selected target haulage vehicle.

2. The computer implemented method of claim 1 further comprising:
identifying the plurality of possible target vehicles; and
generating a set of possible target haulage vehicle identifying data identifying each of the plurality of possible target haulage vehicles, wherein automatically selecting comprises automatically selecting a selected target haulage vehicle, of the plurality of possible target haulage vehicles, based on the set of possible target haulage vehicle identifying data.

3. The computer implemented method of claim 2 wherein automatically selecting a selected target haulage vehicle comprises:
evaluating a selection criterion; and
selecting the selected target haulage vehicle based on the selection criterion.

4. The computer implemented method of claim 3 wherein evaluating a selection criterion comprises:
evaluating a location-based selection criterion corresponding to each of the plurality of possible haulage vehicles.

5. The computer implemented method of claim 4 wherein evaluating a location-based selection criterion comprises:
detecting, as proximity criteria, a proximity of each of the plurality of possible target haulage vehicles relative to the material transfer vehicle, wherein selecting the selected target haulage vehicle based on the selection criterion comprises selecting the selected target haulage vehicle based on the proximity criteria.

6. The computer implemented method of claim 4 wherein evaluating a location-based selection criterion comprises:
detecting, as proximity criteria, a proximity of each of the plurality of possible target haulage vehicles relative to a field feature of a field in which the material transfer vehicle is traveling, wherein selecting the selected target haulage vehicle based on the selection criterion comprises selecting the selected target haulage vehicle based on the proximity criteria.

7. The computer implemented method of claim 4 wherein evaluating a location-based selection criterion comprises:
detecting, as proximity criteria, a proximity of each of the plurality of possible target haulage vehicles relative to an unloading zone, wherein selecting the selected target haulage vehicle based on the selection criterion comprises selecting the selected target haulage vehicle based on the proximity criteria.

8. The computer implemented method of claim 1 wherein automatically selecting a selected target haulage vehicle comprises:
detecting arrival data corresponding to each possible target haulage vehicle;
identifying a first-in-first-out (FIFO) order corresponding to the plurality of possible target haulage vehicles based on the arrival data; and
selecting the selected target haulage vehicle based on the FIFO order. .

9. The computer implemented method of claim 3 wherein evaluating a selection criterion comprises:
detecting truck assignment data indicative of whether any of the plurality of possible target haulage vehicles has an assigned material transfer vehicle, wherein selecting the selected target haulage vehicle based on the selection criterion comprises selecting the selected target haulage vehicle based on the assignment data.

10. The computer implemented method of claim 3 wherein evaluating a selection criterion comprises:
detecting truck accessibility data indicative of whether any of the plurality of possible target haulage vehicles is inaccessible to the material transfer vehicle, wherein selecting the selected target haulage vehicle based on the selection criterion comprises selecting the selected target haulage vehicle based on the accessibility data.

11. The computer implemented method of claim 3 wherein evaluating a selection criterion comprises:
detecting truck-specific capacity data indicative of a remaining capacity in each of the plurality of possible target haulage vehicles, wherein selecting the selected target haulage vehicle based on the selection criterion comprises selecting the selected target haulage vehicle based on the truck-specific capacity data.

12. The computer implemented method of claim 3 wherein evaluating a selection criterion comprises:
comparing the selection criterion to a criteria priority hierarchy.

13. The computer implemented method of claim 3 wherein evaluating a selection criterion comprises:
computing a plurality of selection criteria for each of the plurality of possible target haulage vehicles; and
selecting the selected target haulage vehicle based on the plurality of selection criteria.

14. The computer implemented method of claim 13 wherein selecting the selected target haulage vehicle based on the plurality of selection criteria comprises:
applying the plurality of selection criteria to a machine learning model; and
generating a selection output with the machine learning model, based on the plurality of selection criteria, indicative of the selected target haulage vehicle.

15. The computer implemented method of claim 1 wherein generating a control signal comprises:
generating a control signal to control an operator interface.

16. An agricultural system, comprising:
a multiple haulage vehicle identification system configured to automatically detect a plurality of possible target haulage vehicles available to receive harvested material from a material transfer vehicle;
a target haulage vehicle selection system configured to automatically select a target haulage vehicle, of the plurality of possible target haulage vehicles, to receive harvested material from the material transfer vehicle; and
a control signal generator configured to generate a control signal based on the selected target haulage vehicle.

17. The agricultural system of claim 16 further comprising:
an operator interface system, wherein the control signal generator is configured to generate the control signal to control the operator interface system to output an indication of the selected target haulage vehicle.

18. The agricultural system of claim 17 further comprising:
a location sensor configured to generate a location output indicative of a location of the selected target haulage vehicle; and
a propulsion/steering system on the material transfer vehicle, wherein the control signal generator is configured to generate the control signal to control the propulsion/steering system based on the location of the selected target haulage vehicle.

19. The agricultural system of claim 16 wherein the target haulage vehicle selection system comprises:
a selection criteria generation system configured to generate a value for each of a plurality of selection criteria corresponding to the plurality of possible target haulage vehicles;
a selection criteria evaluation system configured to evaluate the plurality of selection criteria to identify the selected target haulage vehicle; and
a target output generator configured to generate an output indicative of the selected target haulage vehicle.

20. An unloading target identification and selection system, comprising:
at least one processor; and
a memory storing computer executable instructions which, when executed by the at least one processor, cause the at least one processor to perform a method, comprising:
automatically identifying a plurality of possible target haulage vehicles available to receive harvested material from a material transfer vehicle;
automatically selecting a selected target haulage vehicle, of the plurality of possible target haulage vehicles, to receive harvested material from the material transfer vehicle; and
generating a control signal based on the selected target haulage vehicle.
